(19) United States
(12) Patent Application Publication
(10) Pub. No.: US 2015/0225629 A1
(43) Pub. Date: Aug. 13, 2015

(54) REACTIVE POLYOLEFIN HOT-MELT ADHESIVE FOR USE AS A PRE-COATING THAT CAN BE REACTIVATED

(71) Applicant: SIKA TECHNOLOGY AG, Baar (CH)

(72) Inventors: Kai Paschkowski, Jork (DE); Doreen Janke, Alveslohe (DE)

(21) Appl. No.: 14/424,650

(22) PCT Filed: Sep. 11, 2013
(86) PCT No.: PCT/EP2013/068842

§ 371 Date: Feb. 27, 2015

(30) Foreign Application Priority Data
Sep. 11, 2012 (EP) 12183958.3

(51) Int. Cl. C09J 151/00; B32B 27/32; B32B 17/06; B32B 37/06; B32B 27/08; B32B 37/18; B32B 37/12; C09J 123/02; B32B 5/18

(52) U.S. Cl. CPC C09J 151/003; C09J 123/02; B32B 27/32; B32B 17/064; B32B 5/18; B32B 27/08; B32B 37/182; B32B 37/18; B32B 37/1284; B32B 37/1207; B32B 37/06; B32B 2037/1215; B32B 2305/022; B32B 2305/18; B32B 2315/08; B32B 2317/16

(57) ABSTRACT

Hot-melt adhesive compositions are described that have at least one thermoplastic poly-α-olefin that is solid at 25° C. and silane groups, at least one thermoplastic poly-α-olefin that is solid at 25° C. and that does not contain silane groups, and at least one resin that is tackifying at 25° C. The product of the content of the thermoplastic poly-α-olefin with respect to the weight and the degree of grafting of the thermoplastic poly-α-olefin is ≦0.06. In comparison to conventional hot-melt adhesive compositions based on poly-α-olefins, the described hot-melt adhesive compositions are characterized in that the hot-melt adhesive compositions can be reactivated after the processing and cross-linking. That is, the compositions can be put into a liquid or soft state by means of heat and pressure and can be processed well again. At the same time, the described hot-melt adhesives have the physical processing properties characteristic of reactive polyolefin hot-melt adhesives, such as high initial heat resistance, high final strength and heat stability, and good resistance to environmental influences.

### PRIOR ART

In practice, dispersion- or solvent-based polyurethane adhesives are the principal materials used for lamination with heated tools. These adhesive systems have high molecular weights and offer high initial strength following lamination, even at relatively high mold removal temperature. Reactive polyurethane hot melt adhesives have a distinctly lower molecular weight compared with the dispersed and dissolved polyurethane adhesives and thus do not offer high initial strength, especially at elevated temperatures. This group of problems will be designated in the following as the “initial heat resistance” problem.

However, pretreatment of the substrate is necessary when polyurethane-based adhesives are used in the lamination of nonpolar substrates, such as polypropylene or polyethylene, with dispersed or dissolved polyurethane adhesives, since owing to their high polarity they only adhere inadequately to nonpolar substrates. Consequently, polyolefin hot-melt adhesives, also known as hotmelts, are particularly suitable for these applications, since they have highly nonpolar properties and therefore no pretreatment is needed when they are used, for example with polyolefin films.

A special class of reactive hot-melt adhesives that can be used advantageously for laminating purposes is based on polyolefins, especially on silane-grafted polyolefin prepolymers formulated into hot-melt adhesives by mixing with other polymers and resins. The production of such silane-grafted polyolefin prepolymers is described, for example, in U.S. Pat. No. 5,994,474 or in DE 40 00 695 A1.

In the hot-melt adhesives based on silane-grafted poly-α-olefins, after application the adhesive not only binds physically (i.e., by cooling), but upon contact with moisture, the chemically reactive groups, for example methoxysilane groups present in the polymer, also react with water to form silanols, which subsequently undergo reaction with other silanol groups to form covalent bonds between individual polymer molecules as part of a condensation reaction. In this way these adhesives achieve their final properties, especially their high heat stability and resistance to environmental influences.

For thin-layer bonding with such hot-melt adhesives in practice, the method of reactivation is frequently used, i.e., the adhesive is first applied to one side of the substrate, where it sets rapidly. By again applying heat, the adhesive is then reactivated and thus brought into a state in which it can adequately wet the second substrate.

It is typical for the processing of moisture-reactive hot-melt adhesives that these must be processed shortly after the precoating. This can only be guaranteed if the cross-linking of the adhesive proceeds only to a certain degree, i.e., not completely, since otherwise the hot-melt adhesives can no longer be activated. However, it is frequently problematic in practice to accurately maintain this predetermined time window.

Hot-melt adhesive compositions based on silane-functionalized poly-α-olefins have been described in the prior art. For example, EP 2 075 297 A1 discloses hot-melt adhesive compositions which contains a fatty acid amide in addition to a silane group-containing thermoplastic polyolefin that is solid at 25° C. These hot-melt adhesive compositions exhibit good adhesion to polyolefins and therefore are suitable as laminating adhesives for the processing of polyolefin films. It was found with these compositions that despite their good adhesion to polyolefins, they can be very readily separated from Teflon and thus provide advantages in their manufacturing and application processes.

WO 2009/133093 describes hot-melt adhesive compositions containing at least one thermoplastic, silane-grafted poly-α-olefin that is solid at 25° C. and at least one soft resin with a melting point or softening point between −10 and 40° C. These adhesives are characterized by a long open time and rapid development of strength compared with conventional silane-functionalized poly-α-olefin adhesives.

WO 2011/023768 describes hot-melt adhesive compositions corresponding to WO 2009/133093 that also contain a polar-modified polyolefin wax, especially in the form of maleic anhydride-grafted polypropylenes. These compositions are described as advantageous in connection with the bonding of polyethylene and polypropylene films.

WO 2011/109605 A1 discloses an adhesive composition containing a silane group-containing poly-α-olefin polymer, a thermoplastic component with a softening point of at least 120° C., a catalyst and optionally a tackifying compound with a softening point of at least 80° C. WO 2006/131417 A1, on the other hand, is directed toward the use of hot-melt adhesives based on amorphous poly-α-olefins and/or modified, amorphous poly-α-olefins for fixing the back of artificial turf products. WO 2006/102957 A2 discloses a bonding agent in the form of an adhesive for laminating a plastic film on a metal substrate. WO 03/070851 A1 describes the production and use of adhesive and coating materials based on isocyanate and silane functions, respectively, in the form of reactive single-component granulates. DE 10 2008 041 281 A1 describes modified polyolefins with high softening point and plastic deformability in the non-cross-linked state based on partially crystalline polyolefin polymers, with a certain fraction of isotactic poly(propylene) chain elements, wherein one or more silanes are grafted on to the polymer or polymers, as well as the production of the polyolefins and their use in or as adhesives. EP 0 827 994 A2 discloses an adhesive, that contains a silane-grafted, largely amorphous poly-α-olefin, characterized by at least one olefinic double bond and one to three alkoxy groups bonded directly to the silicon and it is cross-linked with water.

Finally, EP 2 336 261 A1 describes hot-melt adhesive compositions which contain a reaction product of a polyisocyanate and a silane reactive with isocyanate in addition to a thermoplastic, silane-grafted poly-α-olefin that is solid at 25° C. The isocyanate-reactive silane used here should have exactly one isocyanate-reactive group selected from hydroxyl groups, mercapto groups or amino groups. The hot-melt adhesives mentioned in EP 2 336 261 A1 are described as adhering well to both polar and nonpolar substrates and have prolonged open time when applied in thin layers. Nevertheless, they are said to rapidly develop the necessary initial strength and maintain their adhesion over a prolonged time, even when stored under hot and moist conditions.

These hot-melt adhesives generally make it possible to achieve high strength with great thermal stability and also have very high initial strength. However, the very short open tine of these hot-melt adhesives is highly problematic and makes them unsuitable for use as laminating adhesives without interim reactivation (i.e., remelting).

Basically such polyolefin hotmelts are suitable for bonding in thin layers, but the fact that they have low initial thermal strength immediately after application is a problem. This makes these adhesives unsuitable especially for laminating three-dimensional structural molded elements with hot tools. In addition, the use of such adhesives often represents a problem in that these have only a brief reactivation time. Reactivation time is defined as the time span between adhesive application and bonding.

The above-described hot-melt adhesives have the additional drawback that they can no longer be remelted by another heat treatment due to strong crosslinking during curing. Thus, the hot-melt adhesives described are not hot-melt adhesives in the conventional sense, but rather reactive hot-melt adhesives, which like the corresponding polyurethane-based reactive hot-melt adhesives can only be applied once, and then cannot be further processed thereafter.

In the prior art, physically quick-hardening hot-melt adhesives are frequently used as alternatives for reactive hot-melt adhesives. First, they are applied to a support material (for example a film or a textile). The precoated materials can be stacked or rolled because the hot-melt adhesive sets quickly. The actual bonding then requires activation of the adhesive by supplying heat.

Following the liquefaction or softening of the hot-melt adhesives the parts to be bonded can be put together. The resulting composite must then cool down in the tool for a certain period of time under application of pressure, so that the adhesive can build up a certain strength. Then, the pressure can be released and the composite can be removed from the processing tool.

One drawback of conventional hot-melt adhesives is their low strength when hot. This means that in practice the tools must be cooled, and a long pressing time is necessary to build up adequate initial strength. Laminating, i.e., bonding of large-area substrates in thin layers, with hot tools is of far greater practical efficiency than laminating where first activation with heat is required and then the adhesive must be cooled down again. On the other hand for laminating with hot tools it is necessary for the adhesive not to become too tacky even at elevated temperature, so that it will have high strength.

Both approaches have advantages, depending on the desired application, however, there is a need for hot-melt adhesives, especially based on poly-α-olefins, that combine the advantages of both approaches.

### PRESENTATION OF THE INVENTION

For applications in which in particular remelting of a hot-melt adhesive is necessary, a need therefore exists for providing an effective hot-melt adhesive composition which overcomes the disadvantages of the prior art and especially is based on olefins, and thus has a long reactivation time and a high initial heat resistance. An additional object of the invention is to provide an adhesive that has a very high initial strength even when hot, but can be reactivated over a very long time period, i.e., can be returned to a moldable state under the influence of heat and pressure.

Surprisingly, these problems are solved by a hot-melt adhesive composition according to claim 1 comprising
(a) at least one thermoplastic silane group-containing poly-α-olefin that is solid at 25° C.,
(b) at least one thermoplastic poly-α-olefin without a silane group that is solid at 25° C. and
(c) at least one resin that is tackifying at 25° C., wherein the product of the content of component (a) with respect to the weight and its degree of grafting is ≦0.06.

In the adhesive composition used, the degree of cross-linking, which is essentially attributable to the at least one thermoplastic poly-α-olefin containing silane groups that is solid at 25° C., is deliberately kept low, so that only a small number of linkages can form. In this way it is possible to achieve a high initial heat resistance after the chemical cross-linking, which allows the unconventional use of hot-melt adhesives according to the invention in hot laminating.

Additional aspects of the present invention are the use of the hot-melt adhesive composition according to the invention for bonding films or fiber materials for use especially in the automotive sector and for producing sandwich elements, especially for the building and trailer sector. An additional aspect of the present invention is a composite comprising a first substrate, a second substrate and a layer of a hot-melt adhesive composition according to the invention applied between them, as well as a method for producing such a composite.

### METHODS OF EXECUTING THE INVENTION

In a first aspect the present invention relates to a hot-melt adhesive composition, comprising
(a) at least one thermoplastic, silane group-containing poly-α-olefin that is solid at 25° C.,
(b) at least one thermoplastic poly-α-olefin without silane groups that is solid at 25° C. and
(c) at least one resin that is tackifying at room temperature,
   wherein the product of the content of component (a) with respect to the weight and the degree of grafting thereof is 0.06.

When above the term “content of component (a) with respect to the weight” is used, this means the weight of component (a) relative to the total hot-melt adhesive composition. For example, when it is present therein with a content of 50 wt-% relative to the total hot-melt adhesive composition, a content of component (a) with respect to the weight of 0.5 is obtained.

The degree of grafting is determined as follows:

$$Degree of grafting ( \% ) = \frac{Quantity of graft}{Quantity of graft base} \times 100$$

The term graft refers to the side chains, while the graft base is the main chain.

The degree of grafting is also usually given as a percentage, which is not included in the calculation as such, but instead corresponding to its actual value. If component (a), for example, has a degree of grafting of 10%, a factor of 0.1 results for the calculation. Preferably, the thermoplastic, silane group-containing poly-α-olefin that is solid at 25° C., is a silane-grafted poly-α-olefin. Particularly preferably the silane group-containing poly-α-olefin has a softening temperature of 70° C. to 150° C., especially of 80° C. to 120° C., and particularly preferably of 90° C. to 110° C. The softening temperature is measured with the ring and ball method according to DIN EN 1238 (dated 2011/07).

Such silane group-containing poly-α-olefins are familiar to the person skilled in the art. For example, they can be produced by grafting unsaturated silanes, such as vinyl-trimethoxysilane, onto a poly-α-olefin. A detailed description of the production of silane-grafted poly-α-olefins can be found, for example, in U.S. Pat. No. 5,994,474 and DE 40 00 695 A1.

A particularly suitable silane group-containing poly-α-olefin that is solid at 25° C. is a silane-grafted polyethylene or polypropylene.

Other preferred silane group-containing poly-α-olefins are silane-grafted poly-α-olefins, which are poly-α-olefins produced by the Ziegler-Natta process, onto which silane groups were grafted. In particular, these are silane-grafted polyethylene homopolymers or polypropylene homopolymers.

The degree of grafting of the silane-grafted poly-α-olefin is advantageously greater than 0.5 wt-%, especially greater than 1.5 wt-% relative to the weight of the polyolefin. If a silane-grafted poly-α-olefin produced according to the Ziegler-Natta process is used as the silane-grafted poly-α-olefin, the degree of grafting is preferably between 1 and 8 wt-%, especially between 1.5 and 5 wt-%.

No relevant limitations exist with regard to the weight fraction of the at least one thermoplastic, silane group-containing poly-α-olefin that is solid at 25° C., provided that the product of the content of component (a) with respect to the weight and the degree of grafting thereof is 0.06. In a preferred embodiment, however, the proportion of all silane group-containing poly-α-olefins in the hot-melt adhesive composition is greater than 40 wt-%; preferably it is between 50 and 65 wt-% and especially between 50 and 60 wt-%. If the proportion is less than 40%, this leads to a significantly reduced initial heat resistance as well as a low final heat stability. On the other hand, if the content of silane group-containing poly-α-olefins is greater than 65%, by remelting the cured adhesive, only a viscosity can be reached at which adequate wetting of the substrate to be bonded can be guaranteed with difficulty.

As was mentioned above, a low degree of cross-linking is necessary for the ability to melt after cross-linking; in the compositions according to the present invention, this is expressed by the product of the content of component (a), with respect to the total weight of the hot-melt adhesive composition, and the degree of grafting thereof, which must be 0.06. The low cross-linking density of the product that can be obtained from the above described hot-melt adhesive composition, as determined by this parameter, guarantees that the hot-melt adhesive can be liquefied or softened again upon exposure to heat and pressure and thus can be processed.

It has proven to be advantageous if the product of the content of component (a) with respect to the weight and the degree of grafting thereof is 0.04, especially 0.025, and particularly preferably 0.02. On the other hand it is necessary for the hot-melt adhesive composition according to the present invention to have a minimum degree of cross-linking in order for it to have an advantageous initial strength and a corresponding heat stability. It was found to be advantageous for the product of the content of component (a) with respect to the weight and the degree of grafting thereof to be 0.005, and especially 0.01.

As component (b) to be included in the hot-melt adhesive, the hot-melt adhesive composition also contains at least one thermoplastic poly-α-olefin without silane groups that is solid at 25° C. This polymer can be a homopolymer or copolymer of unsaturated monomers, especially selected from the group comprising ethylene, propylene, butylene, isobutylene, isoprene, vinyl acetate or vinyl esters with C3 to C12 carboxylic acids and (meth)acrylate. (Meth)acrylate in connection with the invention disclosed here refers to both methacrylates and acrylates. Particularly preferred are ethylene vinyl acetate, atactic poly-α-olefins, polypropylene and polyethylene. Most particularly preferably are atactic poly-α-olefins.

The solid thermoplastic polymers preferably have a softening point of more than 90° C., especially of about 120 to 180° C. A particularly preferred thermoplastic polymer that is solid at 25° C. is a propene-rich amorphous poly-α-olefin.

The molecular weight Mn of the thermoplastic polymers without silane groups advantageously falls in the range of about 7000 to 250000 g/mol.

Preferably, the weight ratio of solid, silane group-containing poly-α-olefins to the solid, thermoplastic poly-α-olefins without silane groups is in the range of about 1:1 to 20:1. Particularly preferably the weight ratio is 2.5 or less: 1, especially 2.2 or less: 1.

A proportion of solid thermoplastic polymer without silane groups of about 5 to 40 wt-%, especially of about 20 to 30 wt-% relative to the total weight of the hot-melt adhesive composition, has proven particularly advantageous.

The hot-melt adhesive composition according to the invention also contains at least one resin that is tackifying at 25° C. and preferably having a melting or softening point in the range of 60 to 100° C., especially between 80 and 100° C. This was measured with the ring and ball method according to DIN EN 4625 (2006/04). The resin may be a natural of a synthetic resin.

In particular, such resins are medium- to high-molecular-weight compounds from the classes of hydrocarbon resins, polyolefins, polyesters, polyethers, poly(meth)acrylates or amino resins.

In a preferred embodiment the resin is a hydrocarbon resin, especially an aliphatic C₅-C₉-hydrocarbon resin or aromatic modified C₅-C₉-hydrocarbon resin.

A particularly suitable aliphatic C₅-hydrocarbon resin was found to be one that is sold commercially by Cray Valley under the trade name of Wingtack® 10 or Wingtack® 86.

Additional suitable resins are, for example, polyterpene resins, for example those sold commercially as Silvares® TR A25 by Arizona Chemical, USA, rosin esters or/and tall oil rosin esters, for example sold commercially as Silvatac® RE12, Silvatac® RE10, Silvatac® R15, Silvatac® RE20, Silvatac® RE25 or Silvatac® RE40 by Arizona Chemical, USA.

Additional suitable resins are, for example, Escorez™ 5040 (Exxon Mobile Chemical). Suitable hydrocarbon resins are, for example, Picco A10 (Eastman Kodak) and Regalite R1010 (Eastman Kodak).

The proportion of all resins is typically 1 to 20 wt-%, especially 5 to 15 wt-% based on the hot-melt adhesive composition.

In addition it proved particularly advantageous if the weight ratio of the resin component to the silane group-containing poly-α-olefin component is less than 0.5. Preferably, the weight ratio falls in the range of about 0.1 to 0.35 and particularly preferably in the range of 0.12 to 0.2.

The hot-melt adhesive composition according to the invention also preferably contains at least one catalyst that accelerates the reaction of silane groups and the concomitant cross-linking of the hot-melt adhesive composition. Within the context of the invention it proved advantageous to use a phosphoric ester or an organotin compound, especially dibutyltin laurate (DBTL). Suitable phosphoric esters for use are, for example, mixed phosphoric acid mono-, -di-, and -triesters resulting from the reaction of phosphorus pentoxide with alcohols. It is advantageous if the alcohols have a mean chain length in the range of 12 to 24, especially in the range of 16 to 20, since the corresponding phosphoric esters have reduced acidity compared with phosphoric acid and thus their reactivity toward decomposition reactions of the silanes is reduced. A commercially available phosphoric ester catalyst is Hordphos MDST, for example.

The catalyst is advantageously to be included in the hot-melt adhesive composition in a quantity of more than 0.05 wt-%, but not more than 5 wt-%, especially in a quantity in the range of about 0.5 to 2 wt-%.

In addition, other auxiliaries and additives may be present in the hot-melt adhesive composition according to the invention, especially those selected from the group comprising fillers, plasticizers, adhesive promoters, UV absorbing agents, UV and heat stabilizers, optical brighteners, pigments, dyes and drying agents.

Particularly advantageous hot-melt adhesive compositions were found to be those that consist essentially of a thermoplastic, silane group-containing poly-α-olefin that is solid at 25° C., at least one thermoplastic poly-α-olefin without silane groups that is solid at 25° C., a tackifying resin, and, optionally a resin a catalyst, optionally a UV stabilizer and optionally an optical brightener.

A particularly advantageous embodiment of the present invention consists of a composition comprising 50 to 65 wt-% of a thermoplastic, silane group-containing poly-α-olefin that is solid at 25° C., 25 to 35 wt-% of a solid thermoplastic poly-α-olefin without silane groups, 5 to 15% of a resin that is tackifying at 25° C., 0.1 to 0.3 wt-% of a catalyst and 0.1 to 1 wt-% of a UV stabilizer and 0.001 to 0.05 wt-% of an optical brightener.

Basically, the production takes place in the usual manner for hot-melt adhesives, known to the person skilled in the art.

The hot-melt adhesive compositions according to the invention are liquefied by melting the thermoplastic constituents. The viscosity of the hot-melt adhesive compositions should be adapted to the application temperature. Typically, the application temperature at which the adhesive exists in a readily workable form falls in the range of 90 to 200° C. In this temperature range the viscosity is about 1500 to 50,000 mPa·s. If the viscosity is substantially higher, application is difficult, whereas if the viscosity is substantially lower than 1500 mPa·s, the adhesive is so free-flowing that during application it runs off of the material surface quickly before it solidifies by cooling.

A particular advantage of the hot-melt adhesive composition according to the invention consists of the fact that it has only a low degree of cross-linking even after hardening, so that the hardened reactive polyolefin hot-melt adhesive can be reactivated by heat. In this process the hardened adhesive becomes soft enough upon application of heat that it can be made to flow under pressure.

The hot-melt adhesive according to the invention is also stable during storage and under usual application conditions, especially in the temperature range of 100 to 200° C., readily workable, and viscosity-stable for a sufficiently long time. This also allows for application with open rollers. In addition, the hot-melt adhesive hardens quickly and completely with moisture, without producing an odor and without forming any bubbles during the process, even when applied in a thick layer. After hardening it has a relatively high final strength and good heat stability as well as good resistance to environmental influences. In particular, the hardened adhesive has a very long “reactivation time,” i.e., a time during which it can be remelted and processed, while it simultaneously guarantees a very high initial heat resistance.

A further aspect of the invention relates to a composite comprising
a first substrate (S1), which may be glass, plastic, wood, a film, a foam or a textile, especially a plastic,
a hot-melt adhesive composition as described above or a corresponding cross-linked hot-melt adhesive composition as well as
a second substrate (S2),
   wherein the hot-melt adhesive composition or the cross-linked hot-melt adhesive composition is disposed between the first substrate (S1) and the second substrate (S2).

The second substrate (S2), also frequently referred to as support, may be of various types or character. For example, the substrates may be made of plastic, especially polyolefin or ABS, metal, lacquered metal, wood, wooden materials, glass or fiber materials. The substrate is preferably a solid molded article.

In particular the second substrate (S2) is a fiber material, especially a natural fiber material. Alternatively, it is preferred for the second substrate (S2) to be a plastic, especially a polypropylene.

Another aspect of the present invention is a method for producing a composite as described above. This method comprises the steps of
(i) melting the hot-melt adhesive composition according to the invention as described above,
(ii) applying the melted hot-melt adhesive composition to a first substrate (S1), which comprises glass, plastic, wood, a film, a foam or a textile, preferably a plastic,
(iii) optionally heating the first substrate (S1), and
(iv) contacting the second substrate (S2) with the melted hot-melt adhesive composition.

Heating the film (S1) makes it soft and it can adapt to the geometry of the carrier without wrinkles forming.

The films used here, especially when polyolefin-films are used, may be decorative films which have a surface texture. This surface texture can be impressed, for example, before, during or after bonding.

It is especially advantageous in this case that the adhesive composition can be applied directly onto the film and that it is not necessary first to apply a primer to it, as is the case, for example, with polyurethane dispersion adhesives.

The invention will be further illustrated below using examples.

### EXAMPLES

A basic hot-melt adhesive formulation containing 28.5 parts by weight of a thermoplastic poly-alpha-olefin without silane groups that is solid at 25° C., 9.7 parts by weight of a resin that is tackifying at room temperature plus 0.15 parts by weight of a catalyst that accelerates the reaction of silane groups, and 0.5 parts by weight of an antioxidant was produced by mixing the respective components. This mixture was mixed in a weight ratio of 10:90 to 90:10 with a thermoplastic, silane group-containing poly-alpha-olefin (silane PAO, Vestoplast 206 V) that is solid at 25° C. The additional samples 1 and 10 listed in Table 1 below, consisted of 100% of the premix or of the thermoplastic, silane group-containing poly-alpha-olefin that is solid at 25° C.

The thermoplastic poly-alpha-olefin used was a propylene-rich amorphous poly-alpha-olefin with a melt viscosity at 190° C. of 25,000±7000 mPa·s and a softening temperature of 161° C. The thermoplastic, silane group-containing poly-alpha-olefin that is solid at 25° C., had a degree of grafting of about 3%, based on the silane groups.

The respective samples were then examined for their bonding properties. For this purpose, test specimens were produced as follows:

The respective adhesive was applied as a 100 μm adhesive film to a TPO film or a textile. The precoated textiles were then kept for about 1 day before they were used further to guarantee that all of the silane groups had reacted. Then, the adhesive film was reactivated by heating and brought into contact with the second substrate. After the composite had cooled again, the rolling peel resistance was determined. The measured values obtained are shown in Table 1.

It is apparent from the experiments that with increasing proportion of the thermoplastic, silane group-containing poly-alpha-olefin that is solid at 25° C., remelting of the adhesives following the reaction of the silane groups is only possible with difficulty. The measured values presented in Table 1 show that the best results were obtained with an average content of about 60% of the silane group-containing poly-alpha-olefin. Although for adhesives with 80 to 100% of thermoplastic, silane group-containing poly-alpha-olefin that is solid at 25° C. to some extent improved rolling peel resistance was found compared with 60% of the component, for these compositions remelting of the adhesive was possible only to a limited extent.

TABLE 1

| | | | | | | | | Product of the content of the |
|---|---|---|---|---|---|---|---|---|
| | | | | | | | | silane group-containing poly-α- |
| | | | | | | | | olefin with respect to the total |
| | | | ABS + | PP Deco- | ABS Dec- | ABS + Corona | Polystyrene | weight of the hot-melt adhesive |
| | PP- | ABS- | Corona- | rative tex- | orative | Decorative | support deco- | composition and the degree of |
| Adhesive | TPO | TPO | TPO | tile | textile | textile | rative textile | grafting thereof |
| 100% premix | 8.8 N/cm | — | — | 0.8 N/cm | 3.1 N/cm | — | 1.5 N/cm | 0.0 |
| 90% premix + | 11.8 N/cm | — | — | 1.5 N/cm | 1.0 N/cm | — | 1.5 N/cm | 0.003 |
| 10% silane | | | | | | | | |
| PAO | | | | | | | | |
| 80% premix + | 9.8 N/cm | — | — | 2.2 N/cm | 2.0 N/cm | — | 1.4 N/cm | 0.006 |
| 20% silane | | | | | | | | |
| PAO | | | | | | | | |
| 70% premix + | 20.8 N/cm | — | — | 6.2 N/cm | 1.7 N/cm | — | 1.4 N/cm | 0.009 |
| 30% silane | | | | | | | | |
| PAO | | | | | | | | |
| 60% premix + | 9.1 N/cm | — | — | 2.9 N/cm | 3.0 N/cm | — | 1.4 N/cm | 0.012 |
| 40% silane | | | | | | | | |
| PAO | | | | | | | | |
| 50% premix + | 10.1 N/cm | — | — | 4.6 N/cm | 3.0 N/cm | — | 1.3 N/cm | 0.015 |
| 50% silane | | | | | | | | |
| PAO | | | | | | | | |
| 40% premix + | 15.5 N/cm | 2.0 N/cm | 4.0 N/cm | 6.5 N/cm | 3.7 N/cm | 3.9 N/cm | 1.3 N/cm | 0.018 |
| 60% silane | | | | | | | | |
| PAO | | | | | | | | |
| 30% premix + | 7.9 N/cm | — | — | 1.1 N/cm | 0.7 N/cm | — | 1.6 N/cm | 0.021 |
| 70% silane | | | | | | | | |
| PAO | | | | | | | | |
| 20% premix + | 7.8 N/cm | — | — | 11.9 N/cm | 2.0 N/cm | — | 1.3 N/cm | 0.024 |
| 80% silane | | | | | | | | |
| PAO | | | | | | | | |
| 10% premix + | 17.1 N/cm | — | — | 17.2 N/cm | 1.5 N/cm | — | 2.0 N/cm | 0.027 |
| 90% silane | | | | | | | | |
| PAO | | | | | | | | |
| 100% silane | 20.1 N/cm | — | — | 21.8 N/cm | 1.4 N/cm | — | 1.6 N/cm | 0.03 |
| PAO | | | | | | | | |

In addition, hot-melt adhesive basic formulations, as described above, were produced, using various tackifying resins, namely Wingtack 95 with a softening temperature of 95° C. and Escorez 1401 with a softening temperature of 115-123° C.

The basic formulation was then mixed in a ratio of 4:6 with the silane group-containing poly-α-olefin (Vestoplast 206 V). The open time (period of time during which further processing is still possible) and the viscosity of these hot-melt adhesive compositions were determined. The test specimens in these cases were produced as described above. The measured values obtained are shown in Table 2. It can be seen that better open times are achieved when tackifying resins with a softening temperature of less than 100° C. are used.

TABLE 2

| | Basic | | Basic | | Basic | |
|---|---|---|---|---|---|---|
| | formulation + | | formulation + | | formulation + | |
| | Vestoplast | | Vestoplast | | Vestoplast | |
| | 206 V | | 206 V + | | 206 V + | |
| | (control) | | Wingtack 95 | | Escorez 1401 | |
| Open time (500 μm, | 50 | s | 70 | s | 60 | s |
| 200° C.) | | | | | | |
| Viscosity at 180° C., | 8900 | mPa · s | 8400 | mPa · s | 9200 | mPa · s |
| 10 rpm | | | | | | |

The following procedure was used for determining the open time: the respective hot-melt adhesive composition was preheated in an oven at a temperature of 200° C. for 30 min. At the same time a scraper (500 μm) and a silicone-coated paper (Sicol, B700, 10 cm width, Laufenberg & Sohn KG) was preheated on a heating plate at 200° C. Then, 20 g samples of each hot-melt adhesive composition were applied to the coated paper on the hot plate at a temperature of 200° C. using the scraper to a thickness of 500 μm. This test specimen was then placed on a supporting surface at room temperature. At regular intervals, a short strip of paper was pressed onto the test specimen (slight pressure with the fingertip) and slowly removed. This procedure was repeated until the behavior at rupture changed from cohesive to adhesive. This time point is recorded as the open time.

To measure the viscosity the respective hot-melt adhesive composition was preheated in a closed container for 20 minutes. Then, a sample of the hot-melt adhesive composition was equilibrated in a viscometer (Brookfield Thermosel) for 20 minutes to a temperature of 180° C. Then, the viscosity measurement was started and the viscosity value found after 5 minutes at 10 rotations per minute was determined.

1. A hot-melt adhesive composition comprising:
(a) at least one thermoplastic, silane group-containing poly-α-olefin that is solid at 25° C.;
(b) at least one thermoplastic poly-α-olefin without silane groups that is solid at 25-° C., and
(c) at least one resin that is tackifying at 25° C.,
wherein the product of the content of component (a) with respect to the weight and the degree of grafting thereof is ≦0.06.

2. The hot-melt adhesive composition according to claim 1, wherein the silane group-containing poly-α-olefin that is solid at 25° C. has a softening temperature of 70° C. to 150° C.

3. The hot-melt adhesive composition according to claim 1, wherein the silane group-containing poly-α-olefin that is solid at 25° C. is a silane-grafted poly-α-olefin.

4. The hot-melt adhesive composition according to claim 1, wherein the silane group-containing poly-α-olefin that is solid at 25° C. is a poly-α-olefin produced by the Ziegler-Natta process, onto which silane groups were grafted.

5. The hot-melt adhesive composition according to claim 1, wherein the product of the content of component (a) and the degree of grafting thereof is ≦0.04.

6. The hot-melt adhesive composition according to claim 1, wherein the thermoplastic poly-α-olefin without silane groups that is solid at 25° C. comprises an atactic poly-α-olefin without silane groups.

7. The hot-melt adhesive composition according to claim 1, wherein the tackifying resin has a melting point or softening point of 10° C. to 120° C.

8. The hot-melt adhesive composition according to claim 1, wherein the tackifying resin is a hydrocarbon resin.

9. The hot-melt adhesive composition according to claim 1, wherein the quantity of tackifying resin is 1 to 20 wt-% relative to the hot-melt adhesive composition.

10. The hot-melt adhesive composition according to claim 1, wherein the weight ratio of all tackifying resins to all silane group-containing poly-α-olefins that are solid at 25° C. is less than 0.5.

11. A method of bonding films, the method comprising: bonding the films with the hot-melt adhesive composition according to claim 1.

12. A composite (1), comprising:
a first substrate (S1), comprising glass, plastic, wood, a film, a foam or a textile,
a hot-melt adhesive composition according claim 1 or a cross-linked hot-melt adhesive composition obtained therefrom and
a second substrate (S2),
wherein the hot-melt adhesive composition or the cross-linked hot-melt adhesive composition is disposed between the first substrate (S1) and the second substrate (S2).

13. A method for producing a composite according to claim 12, the method comprising the steps of:
(i) melting a hot-melt adhesive composition according to claim 1,
(ii) applying the melted hot-melt adhesive composition to a first substrate (S1), which comprises glass, plastic, wood, a film, a foam or a textile,
(iii) optionally heating the first substrate (S1) and
(iv) contacting the second substrate (S2) with the melted hot-melt adhesive composition.

14. The hot-melt adhesive composition according to claim 2, wherein the softening temperature of the silane group-containing poly-α-olefin that is solid at 25° C. is 80° C. to 120° C.

15. The hot-melt adhesive composition according to claim 14, wherein the softening temperature is 90° C. to 110° C.

16. The hot-melt adhesive composition according to claim 3, wherein the silane group-containing poly-α-olefin that is solid at 25° C. is a silane-grafted polyethylene or polypropylene.

17. The hot-melt adhesive composition according to claim 5, wherein the product of the content of component (a) and the degree of grafting thereof is ≦0.025.

18. The hot-melt adhesive composition according to claim 17, wherein the content of component (a) and the degree of grafting thereof is ≦0.02.

19. The hot-melt adhesive composition according to claim 7, wherein the melting point or softening point of 80° C. to 100° C.

20. The hot-melt adhesive composition according to claim 8, wherein the hydrocarbon resin is a aliphatic C₅-C₉-hydrocarbon resin.

21. The hot-melt adhesive composition according to claim 9, wherein the quantity of tackifying resin is 5 to 15-wt % relative to the hot-melt adhesive composition.

22. The hot-melt adhesive composition according to claim 1, wherein the weight ratio is between 0.10 and 0.35.

23. The hot-melt adhesive composition according to claim 22, wherein the weight ratio is between 0.12 and 0.2.

24. The method according to claim 11, wherein the films are polyolefin films, foams or textiles.

25. The method according to claim 24, wherein the hot-melt adhesive composition acts as a laminating adhesive.

26. The composite (1) according to claim 12, wherein the first substrate (S1) is a plastic.

27. The method according to claim 13, wherein the first substrate (S1) is a plastic.
